(19) United States
(12) Patent Application Publication
(10) Pub. No.: US 2008/0077716 A1
(43) Pub. Date: Mar. 27, 2008

(54) DMA transfer control device and semiconductor integrated circuit device

(76) Inventor: Takatsugu Sawai, Osaka (JP)

Correspondence Address: MCDERMOTT WILL & EMERY LLP, 600 13TH STREET, NW, WASHINGTON, DC, 20005-3096, US

(21) Appl. No.: 11/902,558

(22) Filed: Sep. 24, 2007

(30) Foreign Application Priority Data
Sep. 27, 2006 (JP) 2006-262130

(51) Int. Cl. G06F 13/28

(52) U.S. Cl. 710/23

(57) ABSTRACT

A read data counter counts an unread data amount which is a data amount not yet transferred by adding, whenever a read command is issued, a read data amount which should be acquired by the read command and counting down whenever data is read. A read command issue control unit determines whether or not a determination amount of read command reject which is obtained by subtracting the unread data amount from the free space of the internal memory is equal to or more than a read data amount of the following acquisition target, and allows the issue of the read command when the determination result is affirmative.

### BACKGROUND OF THE INVENTION

1. Field of the Invention

The present invention relates to a DMA transfer control device for transferring data between devices.

2. Description of the Related Art

Conventionally, a Direct Memory Access (DMA) transfer which performs data transfer directly between devices without going via a CPU is known widely. The DMA transfer is used in the case where the data transfer of memories is performed directly between both memories.

In the DMA transfer, information required for the transfer, including a data transfer source address, a data transfer destination address, data transfer size, etc., is set on a register etc. of the DMA transfer control device. Afterwards, transfer operation is executed based on control over a transfer start by CPU etc. Since there is no necessity for the transfer control by the CPU at the time of the transfer, compared with the case where going via the CPU, the data transfer can be performed at high speed, and the load of the CPU can be reduced. When transfer of data equivalent to a size set by the register etc. is completed, a completion interrupt of the DMA transfer is asserted by setting up the DMA transfer control device. When the CPU detects the completion interruption of the DMA transfer, the CPU reads the register etc. of the DMA transfer control device, and then supervises a result and a status of the DMA transfer.

As for a bus connected with the DMA transfer control device, a burst transfer in which two or more pieces of by the data are transferred in one lot by the one-time designation of each address is possible in many cases. Moreover, when a protocol of the connection buss is a protocol that can perform precedence issue of a read command or a write command, a transfer rate can be raised in an access to a device having a comparatively large latency (transit delay).

In a usual DMA transfer, required data is read in each set-up size, and is written in after that. Therefore, since the timing of starting to write is after reading is completed, the transfer efficiency is not good when data is transferred to a device with a large latency.

To deal with such a problem, as shown in FIG. 12, a certain conventional DMA transfer control device comprises First-in-First-out (FIFO), supervises the amount of data stored in the FIFO, and determines the timing of writing and reading based on this amount of data. More specifically, the conventional DMA transfer control device determines whether or not there is a free area in the FIFO, and reads data when there is a free area in the FIFO. Moreover, the conventional DMA transfer control device determines whether or not there is an amount of data which can be written in the FIFO, and write the data in the FIFO when there is an amount of data which can be written in the FIFO. For this configuration, for example, refer to Japanese Patent Publication Laid-open No. 2001-142841.

However, in the above-mentioned conventional transmission control device, when the case where precedence issue of a command is performed is assumed, since the permission of the issue of a command is determined only from the present state of the FIFO without recognizing the amount of data related to the command of which the precedence issue is performed, overflow or underflow may occur. Depending on a protocol of the connected bus, it is possible to wait until the state of the FIFO returns to normal, when the overflow or the underflow occurs. However, in such a case, the bus right of the connection bus continues to be acquired, and as a result, a deadlock may be caused when competition with the access of another master occurs. Moreover, when the precedence issue of the command is not performed, the data-transfer velocity cannot be improved because of the access latency of data.

### SUMMARY OF THE INVENTION

Therefore, the main aim of the present invention is to provide a DMA transfer control device that can perform precedence issue of a command only according to timing where the overflow or the underflow of the internal memory does not occur, and also can shorten the data transfer time.

(1) A DMA transfer control device in accordance with the present invention is a DMA transfer control device performing a direct memory access transfer to a transfer destination side from a transfer source side, and comprising an internal memory which stores read data temporarily. The DMA transfer control device includes: a read data counter configured to count an unread data amount which is a data amount not yet transferred by adding a read data amount which should be acquired by a read command one by one whenever the read command is issued, and by counting down whenever data is read; and a read command issue control unit configured to determine whether or not a determination amount of read command reject which is obtained by subtracting the unread data amount from the free space of the internal memory is equal to or more than a read data amount of the following acquisition target, and to allow the issue of the read command when the determination result is affirmative.

In issuing the read command, the read command issue control unit determines whether or not the free space Q0 of the internal memory is equal to or more than the read data amount QR which is going to be acquired from now on. The determination amount of read command reject Jr is used for this determination. As for the determination amount of read command reject Jr, Jr=Q0−Qr holds. The read command issue control unit determines whether or not QR>=QR holds between the read data amount QR of the following acquisition target, and the determination amount of read command reject Jr. At an initial stage, since the unread data amount Qr=0, Jr=Q0, and it is determined as Jr=Q0>=QR. Then, the determination at the initial stage usually becomes affirmative, and the read command issue control unit allows the issue of the read command. Based on the issue of this read command, in the read data counter, the read data amount QR is added to the unread data amount Qr (Qr [symbol] Qr+QR). The determination amount of read command reject Jr (=Q0−Qr) decreases by an amount equivalent to an increase in the unread data amount Qr. Also about the determination amount of read command reject Jr after this reduction, the read command issue control unit determines whether or not Jr=Q0−Qr>=QR holds (QR denotes the read data amount of the following acquisition target). When this determination becomes affirmative, the read command issue control unit allows the issue of the following read command. This is precedence issue of the read command. By this precedence issue, in the read data counter, the following read data amount QR is added to unread data amount Qr, and as a result, the determination amount of read command reject Jr decreases by an amount equivalent to the read data amount QR. On the other hand, when the aforementioned determination becomes negative, the issue of the following read command is not allowed.

The free space Q0 of the internal memory changes dynamically with the execution of the read command and the execution of the write command. When the data read from the internal memory based on the execution of the write command is sent to the transfer destination side, the data amount Q of the internal memory decreases and the free space Q0 increases. Moreover, when the data read from the transfer source side based on the execution of the read command is stored in the internal memory, the data amount Q of the internal memory increases, the free space Q0 decreases, and the unread data amount Qr decreases. A decrease in the unread data amount Qr corresponds, in the determination amount of read command reject Jr=Q0−Qr, to an increase in the value. In the timing where there is no data issue to the transfer destination side from the internal memory, the reduction of the free space Q0 and the reduction of the unread data amount Qr antagonize, and the value of determination amount of read command reject Jr remains unchanged. Therefore, the determination result by the determination amount of read command reject Jr performed above does not change, but a negative state is maintained, and the following read command is not allowed. However, in the timing in which the data is issued to the transfer destination side from the internal memory, the free space Q0 increases by an amount caused by the data issue, and as a result, the value of the determination amount of read command reject Jr increases. When the determination of Jr=Q0−Qr>=QR (QR denotes the read data amount of the following acquisition target) becomes affirmative based on this increase in the determination amount of read command reject Jr, the read command issue control unit allows the issue of the following read command again. This is also the precedence issue of the read command. Also in this case, the following read data amount QR is added to the unread data amount Qr, in the read data counter.

In the above, in performing the precedence issue of the read command, it is possible to shorten the data transfer time without causing overflow, since the precedence issue is performed on the conditions that the overflow of the internal memory is beforehand avoided by the determination amount of read command reject Jr.

(2) Moreover, a DMA transfer control device in accordance with the present invention is a DMA transfer control device performing a direct memory access transfer to a transfer destination side from a transfer source side, and comprising an internal memory which stores read data temporarily. The DMA transfer control device includes: a write data counter configured to count an unwrite data amount which is a data amount not yet transferred by adding a write data amount which should be issued by a write command one by one whenever the write command is issued, and by counting down whenever data is written; and a write command issue control unit configured to determine whether or not a determination amount of write command reject which is obtained by subtracting the unwrite data amount from a data amount stored in the internal memory is equal to or more than a write data amount of the following issue target, and to allow the issue of the write command when the determination result is affirmative.

In issuing the write command, the write command issue control unit determines whether or not the data amount Q of the internal memory is equal to or more than the write data amount QW which is going to be issued from now on. The write command acceptance/rejection determination amount Jw is used for this determination. As for the write command acceptance/rejection determination amount Jw, Jw=Q−Qw holds. The write command issue control unit determines whether or not Jw>=QW holds between the write data amount QW of the following issue target, and the read command acceptance/rejection determination amount Jw. At an initial stage, since the unwrite data amount Qw=0, Jw=Q, and the determination at the initial stage with little data amount Q usually turns into a negative in the determination of Jw=Q>=QW. When the data amount Q increases, and the determination becomes affirmative, the write command issue control unit allows the issue of the write command. Based on issue of this write command, in the write data counter, the write data amount QW is added to the unwrite data amount Qw (Qw←Qw+QW). The write command acceptance/rejection determination amount Jw (=Q−Qw) decreases by an amount equal to the increase in the unwrite data amount Qw. Also about the write command acceptance/rejection determination amount Jw after this decrease, the write command issue control unit determines whether or not Jw=Q−Qw>=QW holds (QW denotes the write data amount of the following acquisition target). When this determination becomes affirmative, the write command issue control unit allows the issue of the following write command. This is precedence issue of the write command. Based on this precedence issue, in the write data counter, the following write data amount QW is added to unwrite data amount Qw, and as a result, the write command acceptance/rejection determination amount Jw decreases by an amount equal to the write data amount QW. On the other hand, when the aforementioned determination becomes negative, the issue of the following write command is not allowed.

The data amount Q of the internal memory changes dynamically with the execution of the read command and the execution of the write command. When the data read from the transfer source side by execution of the read command is stored in the internal memory, the data amount Q of the internal memory increases. Moreover, when the data read from the internal memory by execution of the write command is sent to the transfer destination side, the data amount Q of the internal memory decreases and the unwrite data amount Qw decreases. The decrease in the unwrite data amount Qw corresponds, in the write command acceptance/rejection determination amount Jw=Q−Qw, to an increase in the value. In the timing where there is no data read to the internal memory from the transfer source side, the reduction of the data amount Q and the reduction of the unwrite data amount Qw antagonize, and the value of write command acceptance/rejection determination amount Jw remains unchanged. Therefore, the determination result based on the write command acceptance/rejection determination amount Jw does not change, but a negative state is maintained, and the following write command is not allowed. However, in the timing in which the data is issued to the internal memory from the transfer source side, the data amount Q increases by an amount caused by the data issue, and as a result, the value of the write command acceptance/rejection determination amount Jw increases. When the determination of Jw=Q−Qw>=QW (QW denotes the write data amount of the following acquisition target) becomes affirmative based on the increase of this write command acceptance/rejection determination amount Jw, the write command issue control unit allows the issue of the following write command again. This is also the precedence issue of the write command. Also in this ease, the write data amount QW of the following issue target is added to the unwrite data amount Qw, in the write data counter.

In the above, in performing the precedence issue of the write command, it is possible to shorten the data transfer time without causing underflow, since the precedence issue is performed on the conditions that the underflow of the internal memory is beforehand avoided by the write command acceptance/rejection determination amount Jw.

(3) Moreover, a DMA transfer control device in accordance with the present invention is a DMA transfer control device performing a direct memory access transfer to a transfer destination side from a transfer source side, and comprising an internal memory which stores read data temporarily. The DMA transfer control device includes: a read data counter configured to count an unread data amount which is a data amount not yet transferred by adding a read data amount which should be acquired by a read command one by one whenever the read command is issued, and by counting down whenever data is read; a read command issue control unit configured to determine whether or not a determination amount of read command reject which is obtained by subtracting the unread data amount by the read data counter from the free space of the internal memory is equal to or more than a read data amount of the following acquisition target, and to allow issue of the read command when the determination result is affirmative; a write data counter configured to count an unwrite data amount which is a data amount not yet transferred by adding a write data amount which should be is sued by a write command one by one whenever the write command is issued, and by counting down whenever data is written; and a write command issue control unit configured to determine whether or not a determination amount of write command reject which is obtained by subtracting the unwrite data amount from a data amount stored in the internal memory is equal to or more than a write data amount of the following issue target, and to allow issue of the write command when the determination result is affirmative.

This corresponds to the configuration that combines above-mentioned (1) with (2), and the precedence issue of the read command is performed on the conditions that the overflow of the internal memory is avoided beforehand based on the determination amount of read command reject Jr. Therefore, it is possible to shorten the data transfer time without causing overflow. Furthermore, the write command is issued on the conditions that the underflow of the internal memory is avoided beforehand by the write command acceptance/rejection determination amount Jw. Therefore, it is possible to shorten the data transfer time without causing underflow.

In the DMA transfer control devices of the above-mentioned configuration, there is an aspect of further including a read master ID issue unit configured to output a read master ID which is common to each channel at the time of the issue of the read command.

When configured in this way, the transfer of a different channel can also be treated as transfer from the same master. Even when the data of the read command issued later arrives ahead of the data of the read command issued previously, an adjustment is made by the bus connection etc. so that the read data arrives in the order in which the read command is issued. Therefore, also in the data transfer in which two or more channels are existed, it is possible to maintain the consistency of data.

Moreover, in the DMA transfer control devices of the above-mentioned configuration, there is an aspect of further including: a read command issue unit configured to issue the read command; a write command issue unit configured to issue a write command; a read data acquiring unit configured to acquire the read data; a write data issue unit configured to issue write data; and a write response acquiring unit configured to acquire a write response; wherein the read command issue unit comprises a read command issue control unit and a read master ID issue unit, and the write command issue unit comprises a write command issue control unit, a write master ID issue unit, and processes of the data transfer of different channels are possible in the read command issue unit, in the write command issue unit, in the read data acquiring unit, in the write data issue unit, and in the write response acquiring unit.

When configured in this way, also in the data transfer in which two or more channels mix, each process of the data transfer can be performed sequentially and the data transfer time can be shortened.

Moreover, in the DMA transfer control devices of the above-mentioned configuration, there is an aspect of further including a channel control unit configured to control at least one of the following operating steps: a step in which the read data acquiring unit inherits a channel number from the read command issue unit, a step in which the write command issue unit inherits a channel number from the read command issue unit, a step in which the write data issue unit inherits a channel number from the write command issue unit, and a step in which the write response acquiring unit inherits a channel number from the write data issue unit.

Or, there is an aspect in which: the channel control unit comprises an FIFO for channel; and the FIFO for channel includes at least one of a read pointer for the read command issue unit, a read pointer for the write command issue unit, a read pointer for the write data issue unit, and each read pointer for the write response acquiring unit, which operate respectively independently.

When configured as mentioned above, in each process of the data transfer, since the channel which processes next data after the current data-processing completion can be recognized correctly, so even when two or more channels exist, it is possible to perform the data transfer correctly.

Moreover, in the DMA transfer control devices of the above-mentioned configuration, there is an aspect in which an unread data amount in the read data counter, and/or an unwrite data amount in the write data counter, and/or a read data amount of an acquisition target in the read command which is due to be issued, and/or a write data amount of an issue target in the write command which is due to be issued, are expressed with a unit size set up by the aforementioned DMA transfer control device.

When configured in this way, since the data amount is calculated in unit size, the detailed calculation of data amount is unnecessary, and it is possible to reduce the computation time of a data amount and the circuit area.

Moreover, in the DMA transfer control devices of the above-mentioned configuration, there is an aspect in which: the internal memory is composed by an FIFO; and the FIFO has a data width of the unit size, advances a write pointer even when final read data at the time of a change in the read data channel is insufficient for the unit size, and advances a read pointer even when final write data at the time of a change in the write data channel is insufficient for the unit size.

When configured as mentioned above, in a change in channels, since the valid data is started from the head of unit size, the calculation of a data amount can be performed easily.

Or, in the DMA transfer control devices of the above-mentioned configuration, there is an aspect in which: the internal memory is composed by an FIFO; and the FIFO has a data width of the unit size, advances a write pointer even when final read data of a continuation field of the read data is insufficient for the unit size, and advances a read pointer even when final write data of a continuation field of the write data is insufficient for the unit size.

When configured as mentioned above, since the valid data is started from the head of unit size, in the head of the discontinuous portion of data, it is possible to calculate the data amount easily.

Moreover, a semiconductor integrated circuit device according to the present invention includes: one of the above-mentioned data transfer control devices; and the external storage as the transfer source side or transfer destination side of the data transfer control device.

When configured in this way, even when accessing an external storage of a large access latency, such as the SDRAM, it is possible to prevent access performance from deteriorating by accelerating precedence issue of the command.

In addition, the present invention also includes the DMA transfer control device of the configuration which combines two or more aspects explained above appropriately.

According to the present invention, even when the precedence issue of the command is performed, it is possible to shorten the data transfer time, without causing the overflow or underflow of data stored in the internal memory. Moreover, since the control based on the number of the precedence issues of the command is unnecessary, it is not necessary to limit the number of the precedence issue. Moreover, the calculation required to control the issue of the command becomes easier because such calculation ca be made based on a set unit size. Moreover, the data transfer in which two or more channels exist can be performed correctly.

Since the DMA transfer control device of the present invention can perform precedence issue of the command in the optimal timing while considering the state of the internal memory, it can shorten the data transfer time. Also even in the transfer in which two or more channels mix, since the degradation by the change of channels does not occur, the flexible transfer setting can be performed. Also in a bus adapter including the DMA transfer control function, the data transfer time between buses with different protocols can be shortened.

### BRIEF DESCRIPTION OF THE DRAWINGS

If the embodiments described hereinafter are understood, other aims of the present invention become clear, and they will be specified in the attached claims. And, if this invention is implemented, those skilled in the art will recognize a lot of profits that are not touched in this specification.

In the Drawings:

FIG. 1 is a block diagram showing a schematic configuration of a DMA transfer control device according to a first embodiment of the present invention;

FIG. 2 is a figure showing an example of transfer control according to the first embodiment of the present invention;

FIG. 3 is a block diagram showing a schematic configuration of a DMA transfer control device according to a second embodiment of the present invention;

FIG. 4 is a figure showing an example of channel control according to the second embodiment of the present invention;

FIG. 5 is a figure showing an example of transfer control according to the second embodiment of the present invention;

FIG. 6 is a block diagram showing a schematic configuration of a DMA transfer control device according to a third embodiment of the present invention;

FIG. 7 is a figure showing an example of channel control according to the third embodiment of the present invention;

FIG. 8 is a block diagram showing a schematic configuration of a DMA transfer control device according to a fourth embodiment of the present invention;

FIG. 9 is a block diagram showing a schematic configuration of a DMA transfer control device according to a fifth embodiment of the present invention;

FIG. 10 is a figure showing an example of transfer control according to the fifth embodiment of the present invention;

FIG. 11 is a block diagram showing a schematic configuration of a semiconductor integrated circuit device according to a sixth embodiment of the present invention; and

FIG. 12 is a block diagram showing a schematic configuration of a DMA transfer control device according to the prior art.

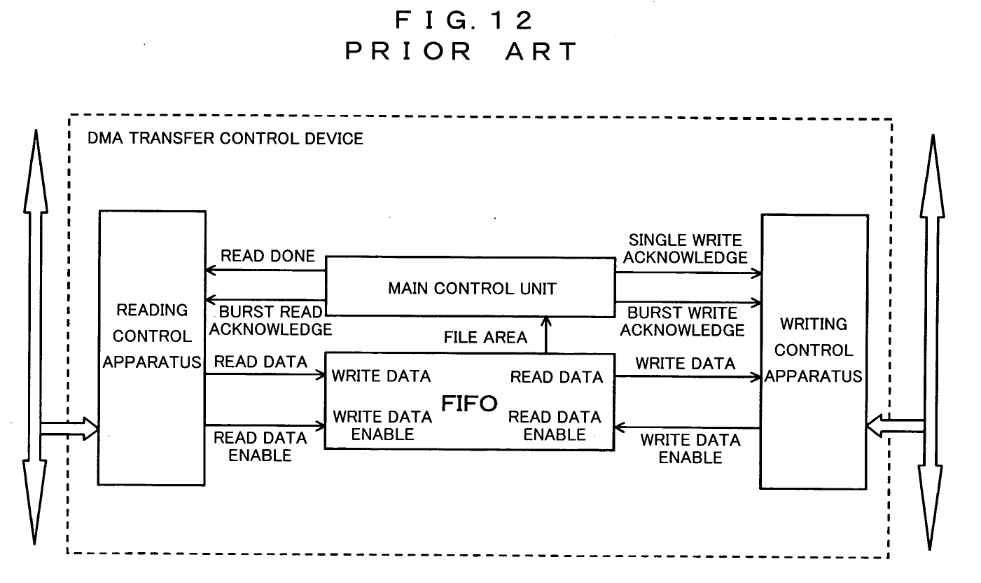

### DETAILED DESCRIPTION OF THE INVENTION

Hereafter, the embodiments of the DMA transfer control device related to the present invention are explained in detail referring to the drawings.

### First Embodiment

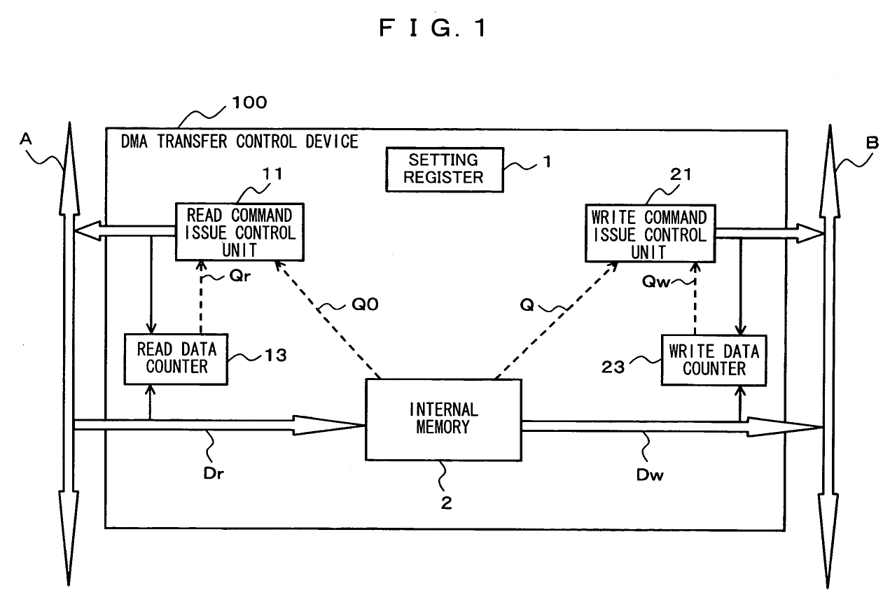

FIG. 1 is a block diagram showing a schematic configuration of a DMA transfer control device 100 according to the first embodiment of the present invention. The DMA transfer control device 100 of this embodiment is connected with the transfer source device through a buss A, and connected with the transfer destination device through a buss B. In FIG. 1, reference numeral 1 denotes a setting register that stores transfer information. The transfer information of this setting register 1 includes a transfer size, a transfer source start address, a transfer destination start address, a transfer source continuum region size, a transfer destination continuum region size, a width of transfer source data, and a width of transfer destination data, etc. Reference numeral 2 denotes an internal memory that is supplied read data Dr by the bus A and outputs write data Dw to the bus B. Reference numeral 11 denotes a read command issue control unit. Reference numeral 13 denotes a read data counter that counts an unread data amount Qr showing an amount of data that has not been acquired yet although the read command is issued by the read command issue control unit 11. Reference numeral 21 denotes a write command issue control unit. Reference numeral 23 denotes a write data counter that counts an unwrite data amount Qw showing an amount of the data that has not been issued yet although a write command issued by the write command issue control unit 21. The DMA transfer control device 100 of this embodiment supplies a free space amount Q0 of the internal memory 2 and an unread data amount Qr by the read data counter 13 to the read command issue control unit 11, and supplies a data amount Q of the internal memory 2 and an unwrite data amount Qw by the write data counter 23 to the write command issue control unit 21.

In addition, the setting register 1 storing the information necessary for the transfer is not limited to what is described above. The setting register 1 may be configured so that the transfer information is given by a different method such as the transfer information is input from an external terminal.

Next, operation of the DMA transfer control device of this embodiment configured as stated above is explained. The read data counter 13 counts down whenever data is actually read, after adding only read data amount QR acquired in the read command when the read command is issued to the unread data amount Qr. Similarly, the write data counter 23 counts down whenever data is actually written, after adding only write data amount QW issued by the write command when write command is issued to the unwrite data amount Qw.

When data transfer is started, first of all, a read command issued on the basis of the setting register 1 is determined, and the read data amount QR acquired by this read command is calculated. The read command issue control unit 11 calculates a determination amount of read command reject Jr by subtracting unread data amount Qr by the read data counter 13 from free space Q0 of the internal memory 2 (Jr=Q0−Qr). Furthermore, the read command issue control unit 11 determines whether or not this determination amount of read command reject Jr is equal to or more than the above-mentioned read data amount QR (Jr>=QR).

When the result of the above-mentioned determination is affirmative, that is, when the following conditions are satisfied, the read command issue control unit 11 allows the issue of the read command. The conditions are as follows:

The read data amount QR is equal to or less than the determination amount of read command reject Jr, and

Even if the read data increases in internal memory 2, the capacity of internal memory 2 is not exceeded.

The issued read command is sent to the transfer source device through the bus A, and the read data Dr from the transfer source device is sent to the DMA transfer control device 100 sequentially through the bus A. The read data Dr is once written in the internal memory 2.

On the write side, the write data counter 23 determines a write command to be issued on the basis of the register of a channel engaged in transfers in the setting register 1, and calculates write data amount Qw to be issued by this write command. The write command is sue control unit 21 calculates write command acceptance/rejection determination amount Jw by subtracting an unwrite data amount Qw by the write data counter 23 from data amount Q of the internal memory 2 (Jw=Q−Qw). Furthermore, the write command issue control unit 21 determines whether or not this write command acceptance/rejection determination amount Jw is equal to or more than the above-mentioned write data amount QW (Jw>=QW).

When the result of the above-mentioned determination is affirmative, that is, when the following conditions are satisfied, the write command issue control unit 21 allows the issue of the write command. The conditions are as follows:

The write data amount QW is equal to or less than the write command acceptance/rejection determination amount Jw, and

Even if the write data is issued from the internal memory 2, the data amount of the internal memory 2 is not minus.

The issued write command is sent to the transfer destination device through the bus B. The internal memory 2 issues write data Dw according to this write command. The issued write data Dw is sent to the transfer destination device through the bus B.

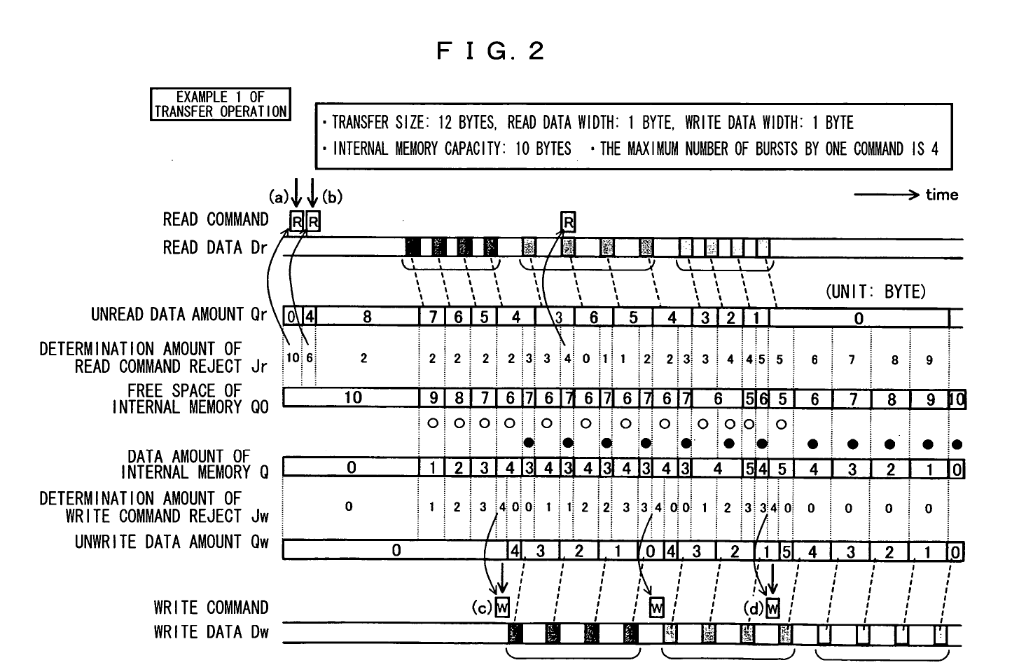

One example of the transfer is shown in FIG. 2. The setting register 1 is assumed to be set as follows:

The transfer size is 12 bytes;

The read data width is 1 byte;

The write data width is 1 byte; and

All continuum regions are transferred. Moreover, it is also assumed that the capacity of the internal memory 2 is 10 bytes, and the number of bursts of data by one command is defined as being 4 time or less on the basis of the protocol of the connected buses A and B.

The contents of FIG. 2 will be hereunder outlined. When the free space Q0 is added to the data amount Q of the internal memory 2, the result always becomes 10 (Q+Q0=10). The determination amount of read command reject Jr is the amount obtained by subtracting the unread data amount Qr from the free space Q0 (Jr=Q0−Qr). The write command acceptance/rejection determination amount Jw is the amount obtained by subtracting the unwrite data amount Qw from the data amount Q (Jw=Q−Qw). A white circle means that 1 byte of the read data Dr is read into the internal memory 2. A black circle means that 1 byte of the write data Dw is issued from the internal memory 2. When determination amount of read command reject Jr is larger than the read data amount QR by 4 bytes or more, the read command is allowed (precedence issue). When write command acceptance/rejection determination amount Jw is larger than the write data amount QW by 4 bytes or more, the write command is allowed (precedence issue).

First of all, at (a) of FIG. 2, the read command issue control unit 11 calculates the read data amount QR to acquire on the basis of a read command to be issued. Here, this read data amount QR is determined as 4 bytes based on the read data width (1 byte) and the maximum number of bursts (4 times) (QR=1×4=4). Moreover, the read command issue control unit 11 calculates that the determination amount of read command reject Jr (=Q0−Qr=10−0) is 10 bytes by subtracting 0 byte of the unread data amount Qr from 10 bytes of the free space Q0 of the internal memory 2. Comparing this determination amount of read command reject Jr and the above-mentioned read data amount QR (=4 bytes), Jr>=QR (10>4) holds. Therefore, it can be considered that the internal memory 2 does not overflow even when the data is read (It can be considered that the overflow can be avoided). Therefore, the read command issue control unit 11 allows the issue of the read command. Moreover, the read data counter 13 increases the counted unread data amount Qr by 4 bytes on the basis of the issue of the read command (Qr←Qr+QR=0+4=4).

Next, at (b) of FIG. 2, the read command issue control unit 11 determines that the read data amount QR to acquire on the basis of a read command to be issue is 4 bytes. Furthermore, the read command issue control unit 11 calculates that the determination amount of read command reject Jr (=Q0−Qr=10−4) is 6 bytes by subtracting the unread data amount Qr (4 bytes) from the free space Q0 (10 bytes) of the internal memory 2. Comparing this determination amount of read command reject Jr (6 bytes) and the above-mentioned read data amount QR (4 bytes), Jr>=QR (6>4) holds. Therefore, it can be considered that the internal memory 2 does not overflow even when the data is read (It can be considered that the overflow can be avoided). Therefore, the read command issue control unit 11 allows the issue of the read command again. Although the read command of the previous time is not completed at this timing, the required time for read data acquisition can be shortened by issuing the read command as the precedence issue.

The write command issue control unit 21 calculates the write data amount QW. The write data amount QW is issued on the basis of a write command to be issued. Here, the write data amount QW is determined as 4 bytes based on the write data width (1 byte) and the maximum number of bursts (4 times) (QW=1×4=4). When the read data Dr is acquired on the basis of the issue of the read command, the data is accumulated in the internal memory 2. At (c) of FIG. 2, although the data amount Q of the internal memory 2 is 4 bytes, 0 byte of the unwrite data amount Qw is subtracted from this data amount Q and the write command acceptance/rejection determination amount Jw (=Q−Qw=4−0) is calculated as 4 bytes. Comparing this write command acceptance/rejection determination amount Jw (4 bytes) and the above-mentioned write data amount QW (4 bytes), Jw>=QW holds. Therefore, it can be considered that data necessary for the write is secured (It can be considered that the underflow can be avoided). Therefore, the write command issue control unit 21 allows the issue of write command.

Moreover, at (d) of FIG. 2, the read command of the previous time is not completed. However, since the data amount Q of the internal memory 2 is 5 bytes, the write command issue control unit 21 calculates that the write command acceptance/rejection determination amount Jw (=Q−Qw=5−1) is 4 bytes by subtracting the unwrite data amount Qw (1 byte) from this data amount Q. Comparing this write command acceptance/rejection determination amount Jw (4 bytes) and the above-mentioned write data amount QW (4 bytes), Jw>=QW holds. Therefore, the data amount necessary for the write can be confirmed. Therefore, the write command issue control unit 21 performs the precedence issue of the write command. Thus, the read and the write including the precedence issue are executed sequentially.

In addition, these explanations are just examples and are not limited toe the above. According to the method explained above, the precedence issue of commands can be performed in the optimal timing according to the state of the internal memory, and the data transfer time can be shortened.

### Second Embodiment

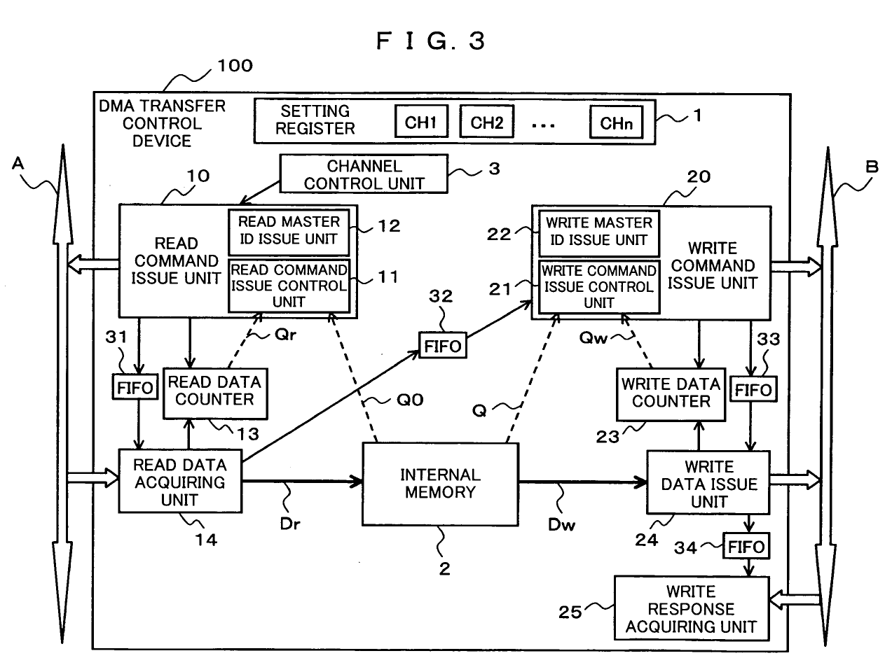

FIG. 3 is a block diagram showing a schematic configuration of a DMA transfer control device 100 according to the second embodiment of the present invention. As for the DMA transfer control device 100 of this embodiment, a read command issue unit 10 and a read data acquiring unit 14 are connected with a bus A with which a transfer source device is connected, and a write command issue unit 20, a write data issue unit 24, and a write response acquiring unit 25 are connected with a bus B with which a transfer destination device is connected. The setting register 1 stores transfer information of each channel. As for the transfer information, it is similar to that of the first embodiment. The Read command issue unit 10 includes a read command issue control unit 11 and a read master ID issue unit 12 that issues read master ID common to each channel, and the write command issue unit 20 includes a write command issue control unit 21 and a write master ID issue unit 22 that issues write master ID common to each channel. The internal memory 2 is supplied read data Dr from the read data acquiring unit 14, and outputs write data Dw to the write data issue unit 24. Reference numeral 3 is a channel control unit that controls a channel transferred by all the parts. Reference numeral 31 denotes an FIFO that stores channel information executed by the read command issue unit 10, reference numeral 32 denotes an FIFO that stores channel information executed by the read data acquiring unit 14, reference numeral 33 denotes an FIFO that stores channel information executed by the write command issue unit 20, and reference numeral 34 denotes an FIFO that stores channel information executed by the write data issue unit 24. As for supplying free space Q0 of the internal memory 2 and unread data amount Qr by the read data counter 13 to the read command issue control unit 11, and supplying data amount Q of the internal memory 2 and unwrite data amount Qw by the write data counter 23 to the write command issue control unit 21, it is similar to that of the first embodiment. The explanation is omitted about other configurations since they are similar to those of the first embodiment.

Next, operation of the DMA transfer control device of this embodiment configured as stated above is explained. When the read command issue unit 10 issues a read command to the bus A, the read data counter 13 increases the unread data amount Qr by read data amount QR acquired by the read command, and counts down whenever read data acquiring unit 14 acquires read data Dr from the bus A and stores the read data Dr in the internal memory 2. Similarly, when the write command issue unit 20 issues a write command to the bus B, the write data counter 23 adds the write data amount QW issued by the write command to the unwrite data amount Qw, and counts down whenever the write data issue unit 24 reads write data from the internal memory 2 and issues the write data to the bus B.

Next, a method of the data transfer in the DMA transfer control device of this embodiment is explained. First of all, a channel to which data is transferred by the channel control unit 3 is designated by the read command issue unit 10. The read command issue unit 10 determines a read command to be issued on the basis of the register of the designated channel of the setting register 1, and calculates read data amount QR acquired on the basis of this read command. After calculating the determination amount of read command reject Jr by subtracting the unread data amount Qr by the read data counter 13 from the free space Q0 of the internal memory 2 (Jr=Q0−Qr), the read command issue control unit 11 determines whether or not this determination amount of read command reject Jr is equal to or more than the above-mentioned read data amount QR (Jr>=QR).

When the result of the above-mentioned determination is affirmative, that is, when the following conditions are satisfied, the read command issue control unit 11 allows the issue of the read command. The conditions include as follows:

The read data amount QR is equal to or less than the determination amount of read command reject Jr, and

Even if the read data increases in internal memory 2, the capacity of internal memory 2 is not exceeded.

The read master ID issue unit 12 issues a read master ID for identifying the master from which the transfer is made, at the same time when the read command is issued. Here, even when it is a different channel, the read master ID issue unit 12 issues the same read master ID. Moreover, the read master ID issue unit 12 adds the read data amount QR acquired on the basis of the read command to the unread data amount Qr of the read data counter 13 (Qr←Qr+QR). Furthermore, the read master ID issue unit 12 stores a channel identification number in the FIFO 31 for the channel, at the same time when a first read command of each channel is issued.

The issued read command is sent to the transfer source device through the bus A, and the read data from the transfer source device is sent to the read data acquiring unit 14 sequentially through the bus A. The bus A can hold read data Dr, further cheeks the read master ID of the read command that passes therethrough, and makes an adjustment to send the read data Dr to the master in the order in which commands are issued when the two or more read commands that have the same read master ID are is sued. Here, when the data of the read command issued later arrives earlier than the data of the read command issued earlier, the bus A holds the data without sending the data to the master. And then, when the data of the read command issued earlier comes, the bus A sends the data issued earlier to the master, and then sends the data issued later that the bus A hs held to the master. Therefore, the data integrity can be kept in the data transfer where two or more channels exist together.

When acquiring data is completed or at its initial state, the read data acquiring unit 14 determines the channel executed according to an identification number of a head channel of the FIFO 31, and starts acquisition of read data. The read data acquiring unit 14 determines the amount and the address location of read data to be acquired with reference to the contents of the register of the corresponding channel in the setting register 1. In addition, since the read master ID at the time of issue of the read command is made common to the channel, the read data arrives to the read data acquiring unit 14 in the order in which commands are issued even when the read command of another channel is issued later. The read data to be acquired is once written in the internal memory 2, and the read data counter 13 counts down the unread data amount Qr by one at this time (Qr←Qr−1). Moreover, the read data acquiring unit 14 stores the channel identification number in the FIFO 32 for the channel simultaneously with the first read data acquisition of each channel.

When the issue of the command is completed or at its initial state, the write command issue unit 20 starts issue of a write command after determining the channel executed according to the identification number of the head channel of the FIFO 32. That is, the write command issue unit 20 firstly determines a write command to be issued on the basis of the register of the above-described designated channel of the setting register 1, and calculates write data amount QW to be issued on the basis of this write command. After calculating the write command acceptance/rejection determination amount Jw by subtracting the unwrite data amount Qw by the write data counter 23 from the data amount Q of the internal memory 2 (Jw=Q−Qw), the write command issue control unit 21 determines whether or not this write command acceptance/rejection determination amount Jw is equal to or more than the above-mentioned write data amount QW (Jw>=QW).

When the result of the above-mentioned determination is affirmative, that is, when the following conditions are satisfied, the write command issue control unit 21 allows the issue of the write command. The conditions are as follows:

The write data amount QW is equal to or less than the write command acceptance/rejection determination amount Jw, and

Even if the write data is issued from the internal memory 2, the data amount of the internal memory 2 is not minus.

Although the write master ID issue unit 22 issues a write master ID for identifying the master from which the transfer is made at the same time when the write command is issued, even when it is a different channel in that ease, the write master ID issue unit 22 issues the same write master ID. Moreover, the write master ID issue unit 22 adds the write data amount issued on the basis of the write command to the unwrite data amount Qw of the write data counter 23. Furthermore, the write master ID issue unit 22 stores a channel identification number in the FIFO 33 for the channel, at the same time when a first write command of each channel is issued.

When the issue of the data is completed or at its initial state, the write data issue unit 24 starts the issue of write data after determining the channel executed according to the identification number of the head channel of the FIFO 33. The amount and address location of the write data to be issued are determined from the register of the corresponding channel in the setting register. Although the write data received from the internal memory 2 is issued to the bus B, the write data counter 23 counts down the unwrite data amount Qw by one at this time (Qw←Qw−1). Furthermore, the write data issue unit 24 stores a channel identification number in the FIFO 34 for the channel, at the same time when issuing the first write command of each channel.

The issued write command and write data are sent to the transfer destination device through the bus B, and a write response signal from the transfer destination device is sent to the write response acquiring unit 25 sequentially through the bus B. The bus B can hold the write response signal, checks the write master ID of the write command that passes therethrough, and makes an adjustment to send the write response to the DMA transfer control device 100 in the order in which commands are issued when the two or more write commands that have the same write master ID are issued by the write data issue unit 24. When the response of the write command issued later arrives earlier than the response of the write command issued earlier, the bus B holds the response without sending the response to the DMA transfer control device 100. And then, when the response of the write command issued earlier comes, the bus B sends the response issued earlier to the DMA transfer control device 100, and then sends the response that the bus B has held to the master. Therefore, the data integrity can be kept in the data transfer where two or more channels exist together.

When acquiring response is completed or at its initial state, the write response acquiring unit 25 determines the channel executed according to an identification number of a head channel of the FIFO 34, and starts acquisition of response. The number of acquired responses is determined from the register of the corresponding channel in the setting register 1. The write response acquiring unit 25 determines that it completes the data transfer of the corresponding channel when a necessary number of responses are acquired, and executes completion interrupt and other processes. In addition, since the write master ID at the time of issue of the write command is made common to the channel, the response arrives to the write response acquiring unit 25 in the order in which commands are issued even when the write command of another channel is issued later.

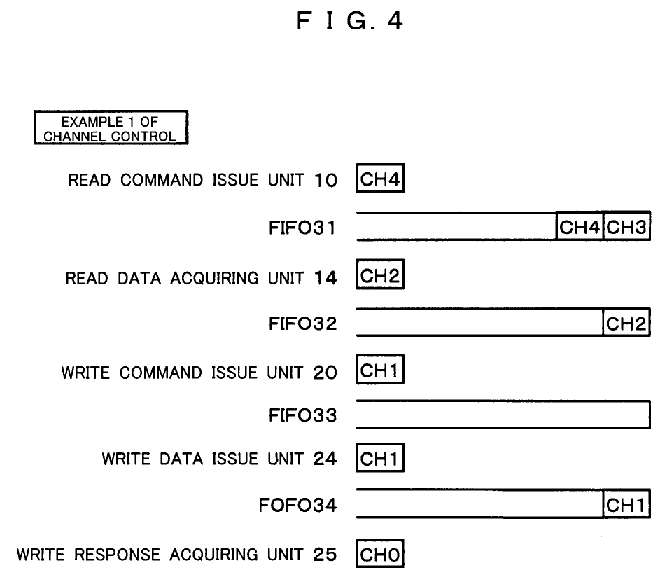

An example of controlling the channel is shown in FIG. 4. This shows the state of the channel and the FIFO for channel which have been transmitted in each control unit in a certain time, in the DMA transfer in the order of CH0, CH1, CH2, CH3, and CH4. The state of each channel is as follows. That is: CH0 is in the state in which the process is completed up to the issue of write data and the acquisition of write response is underway; CH1 is in the state in which the process is completed up to the issue of read data and the issue of the write command and write data is underway; CH2 is in the state in which the process is completed up to issue of the read command, the acquisition of the read data is underway and the write is not yet executed; CH3 is in the state in which the process is completed up to the issue of the read command and the read data is not yet acquired; and CH4 is in the state in which the issue of the read command is underway and read data is not yet acquired. In each control unit, when transferring the current channel is completed, data is sent from the FIFO with which the channel to be executed next is connected. Therefore, the channel control can be performed according to correct timing.

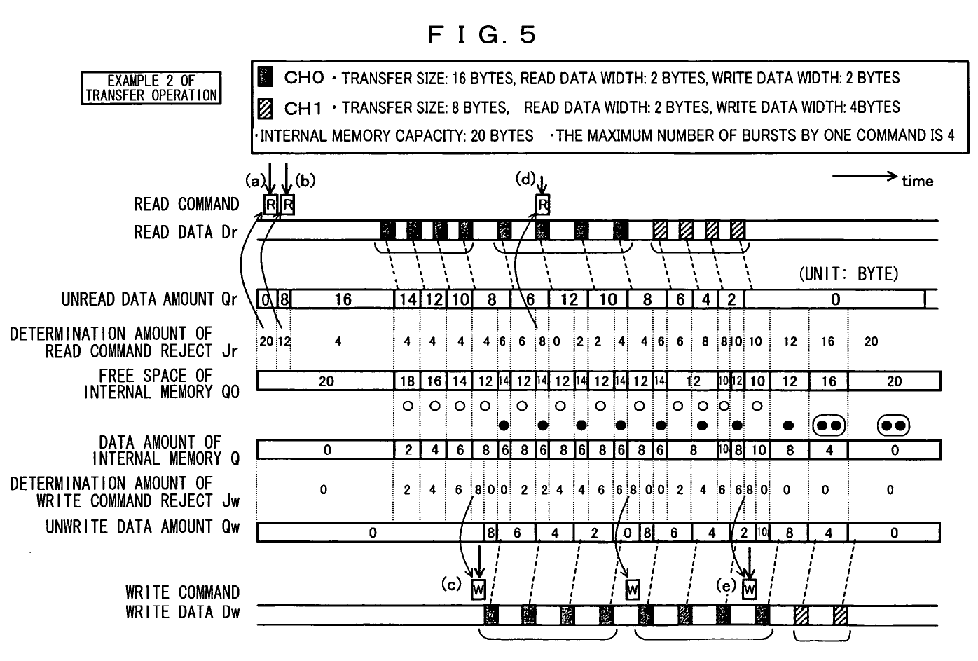

One example of the transfer with two or more channels is shown in FIG. 5. In this example, the setting register 1 is set so as to satisfy the following conditions.

### In channel CH0:

The transfer size is 16 bytes;

Read data width is 2 bytes; and

Write data width is 2 bytes.

### In channel CH1:

The transfer size is 8 bytes;

Read data width is 2 bytes; and

Write data width is 4 bytes.

In each channel:

All continuum regions are transferred.

Moreover, the capacity of the internal memory 2 is assumed 20 bytes, and the number of bursts of data by one command is assumed to be defined as 4 times based on the protocol of connected bus A and the protocol of connected bus B. It is assumed that the transfer is performed in the order of CH0 and CH1.

First of all, at (a) of FIG. 5, the read command issue control unit 11 calculates the read data amount QR to acquire on the basis of the CH0 read command to be issued. Here, this read data amount QR is determined as 8 bytes based on the read data width (2 bytes) and the maximum number of bursts (4 times) (QR=2×4=8). Moreover, the read command issue control unit 11 calculates that the determination amount of read command reject Jr (=Q0−Qr=20−0) is 20 bytes by subtracting 0 bytes of the unread data amount Qr from 20 bytes of the free space Q0 of the internal memory 2. Comparing this determination amount of read command reject Jr and the above-mentioned read data amount QR (=8 bytes), Jr>=QR (20>8) holds. Therefore, it can be considered that the internal memory 2 does not overflow even when the data is read (It can be considered that the overflow can be avoided). Therefore, the read command issue control unit 11 allows the issue of the read command. Moreover, the read data counter 13 increases the unread data amount Qr by 8 bytes on the basis of the issue of the read command (Qr←Qr+QR=0+8=8).

Next, at (b) of FIG. 5, the read command issue control unit 11 determines that the read data amount QR to acquire on the basis of the issued read command is 8 bytes. Furthermore, the read command issue control unit 11 calculates that the determination amount of read command reject Jr (=Q0−Qr=20−8) is 12 bytes by subtracting the unread data amount Qr (8 bytes) from the free space Q0 (20 bytes) of the internal memory 2. Comparing this determination amount of read command reject Jr (12 bytes) and the above-mentioned read data amount QR (8 bytes), Jr>=QR (12>8) holds. Therefore, it can be considered that the internal memory 2 does not overflow even when the data is read (It can be considered that the overflow can be avoided). Therefore, the read command issue control unit 11 allows the issue of the read command again. Although the read command of the previous time is not completed at this timing, the required time for read data acquisition can be shortened by issuing the read command as the precedence issue.

The write command issue control unit 21 calculates the data amount of the write data (hereafter, it is called “write data amount QW”) issued on the basis of the write command to be issued. Here, the write data amount QW is determined as 8 bytes based on the write data width (2 bytes) and the maximum number of bursts (4 times) (QW=2×4=8). When the read data Dr is acquired on the basis of the issue of the read command, the data is accumulated in the internal memory 2. At (c) of FIG. 5, although the data amount Q of the internal memory 2 is 8 bytes, the write command issue control unit 21 subtracts zero byte of the unwrite data amount Qw from this data amount Q and calculates that the write command acceptance/rejection determination amount Jw is 8 bytes (=Q−Qw=8−0). Comparing this write command acceptance/rejection determination amount Jw (8 bytes) and the above-mentioned write data amount QW (8 bytes), Jw>=QW holds. Therefore, it can be considered that data necessary for the write is secured (It can be considered that the underflow can be avoided). Therefore, the write command issue control unit 21 allows the issue of write command.

Moreover, at (d) of FIG. 5, although the read command issue control unit 11 issues the read command of CH1 during the transfer of CH0, since the use of the unread data amount Qr and the free space Q0 of the internal memory 2 is common to the channels, the method of the issue control by read command issue control unit 11 does not vary with a channel. Moreover, at (e) of FIG. 5, although the write command of CH1 is issued during the transfer of CH0, the method of the issue control by the write command issue control unit 21 does not vary with a channel as in the case of the time of read. Therefore, the read and the write including the precedence issue can be executed sequentially without the distinction of the channels.

In addition, these explanations are only examples. If a bus protocol does not need the write response, the write response acquiring unit 25 may be omitted. Moreover, the write master ID may be ID inherent in each channel. As such, the configuration is not limited to those described above.

According to this embodiment, in each processing of read or write, since the transfer of various channels can be performed in the optimal timing according to the state of an internal memory, even when the transfer of two or more channels are intermingled, the data transfer time can be shortened.

### Third Embodiment

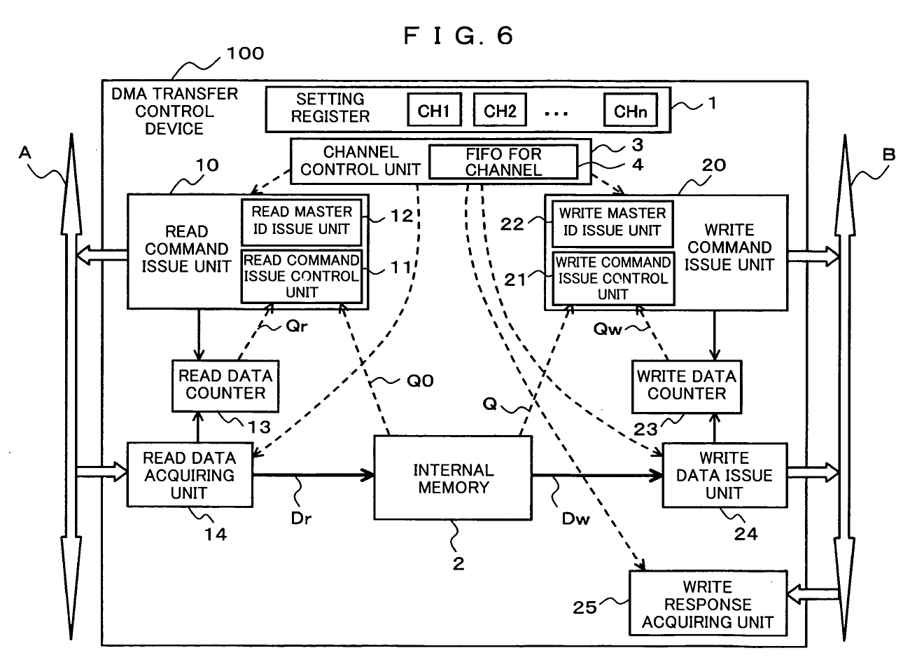

FIG. 6 is a block diagram showing a schematic configuration of a DMA transfer control device 100 according to the third embodiment of the present invention. In FIG. 6, the same reference numeral(s) as in FIG. 3 for the second embodiment means the same configuration element(s). In this embodiment, the channel control unit 3 that controls the channel to which the data is transferred in all the parts has an FIFO 4 for the channel. The explanation is omitted about other configurations since they are similar to those of the second embodiment.

Next, a method of the data transfer in the DMA transfer control device of this embodiment is explained. About data processing methods other than the channel control, they are completely the same as those of the second embodiment. The method of channel control is explained. First of all, the channel to which the data is transferred is written in the FIFO 4 for channels. The FIFO 4 for the channel has a read pointer for each control unit of the read command issue unit 10, the read data acquiring unit 14, the write command issue unit 20, the write data issue unit 24, and the write response acquiring unit 25. Each control unit, at a transfer completion state or at its initial state, advances the read pointer by one step, and starts the transfer process of the channel that the read pointer indicates. The channel number written in the FIFO 4 for the channel is read in the order of the read pointer for the read command issue unit 10, the read data acquiring unit 14, the write command issue unit 20, the write data issue unit 24, and the write response acquiring unit 25. Therefore, the transfer of each channel is performed correctly.

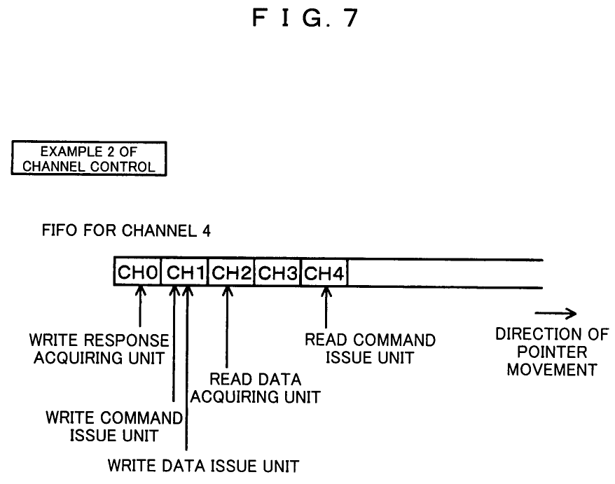

An example of the channel control is shown in FIG. 7. This shows the state of the channel which has been transferred in each control unit in a certain time, in the DMA transfer in the order of CH0, CH1, CH2, CH3, and CH4. The state of each channel is as follows.

CH0 is in the state in which the process is completed up to the issue of write data and the acquisition of write response is underway;

CH1 is in the state in which the process is completed up to the issue of read data, and the issue of the write command and write data are underway;

CH2 is in the state in which the process is completed up to the issue of the read command, the acquisition of the read data is underway, and the write is not yet executed;

CH3 is in the state in which the process is completed up to the issue of the read command and read data is not yet acquired; and

CH4 is in the state in which the issue of the read command is completed and the read data is not yet acquired.

Although each control unit advances the read pointer, and designates the channel which is executed next when the transfer of the current channel is completed, since the process has been completed for this channel up to the previous control unit, the transfer can be made according to the correct timing.

In addition, these explanations are just examples. If a bus protocol does not need the write response, the write response acquiring unit 25 may be omitted. Moreover, the write master ID may be ID inherent in each channel. As such, the configuration is note limited to those described above.

According to this embodiment, in each processing of read or write, since the transfer of various channels can be performed in the optimal timing according to the state of an internal memory, even when the transfer of two or more channels are intermingled, the data transfer time can be shortened.

### Fourth Embodiment

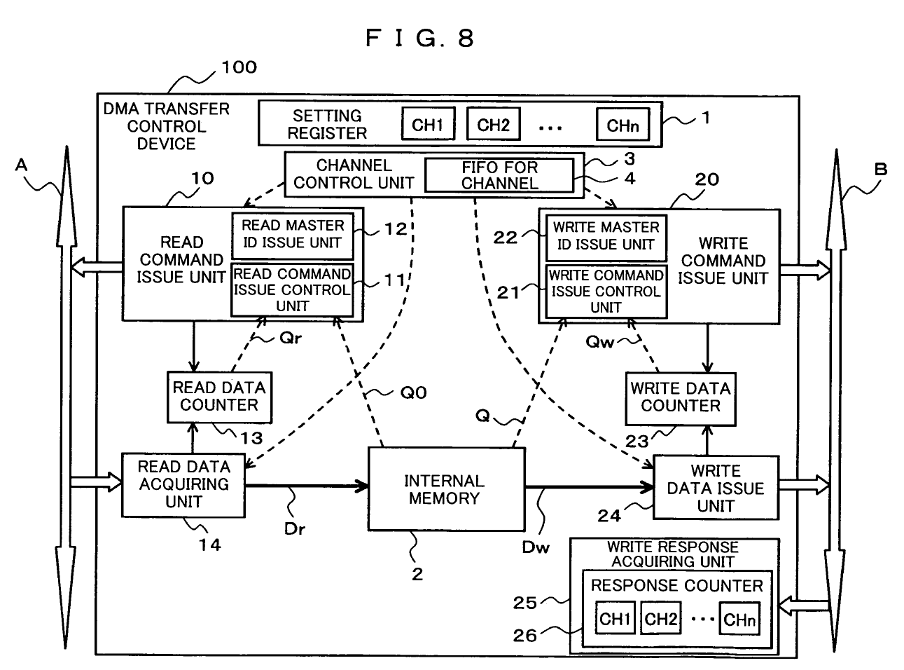

FIG. 8 is a block diagram showing a schematic configuration of a DMA transfer control device 100 according to the fourth embodiment of the present invention. In FIG. 8, the same reference numeral(s) as in FIG. 6 of the third embodiment means the same configuration element(s). In this embodiment, the write response acquiring unit 25 has a response counter 26 for each channel. The explanation is omitted about other configurations since they are similar to those of the third embodiment.

Next, a method of the data transfer in the DMA transfer control device of this embodiment is explained. Except the operation about the write response, the method is the same as that of the third Embodiment. A part different from the third embodiment is discussed from now on. First of all, the FIFO 4 for channel has a read pointer for each control units of the read command issue unit 10, the read data acquiring unit 14, the write command issue unit 20, and the write data issue unit 24. However, the FIFO 4 for the channel does not have the read pointer for the write response acquisition. Therefore, the FIFO 4 for the channel is not provided with a channel that controls the write response acquiring unit 25, and is able to receive the write response of all the channels.

Moreover, at the time of the issue of the write command, the write master ID issue unit 22 issues IDs which are not common to all the channels but vary from one channel to another. Therefore, the order in which the write responses are returned is not necessarily the order in which the write commands are issued.

The response counter 26 of each channel in the write response acquiring unit 25 counts up when the channel issues a write command, and counts down when the write response of this channel is acquired. In the state where all required transfers of this channel are issued, when the response counter 26 of this channel is set to 0, it can be recognized that the transfer of this channel is completed. In addition, these explanations are just examples, and are not limited to this.

According to this embodiment, in each processing of read or write, the transfer of each channel can be performed in the optimal timing according to the state of an internal memory. Therefore, even when the transfers of two or more channel are intermingled, the data transfer time can be shortened, and the DMA transfer completion of a channel can be notified in the order in which write thereof is completed earlier.

### Fifth Embodiment

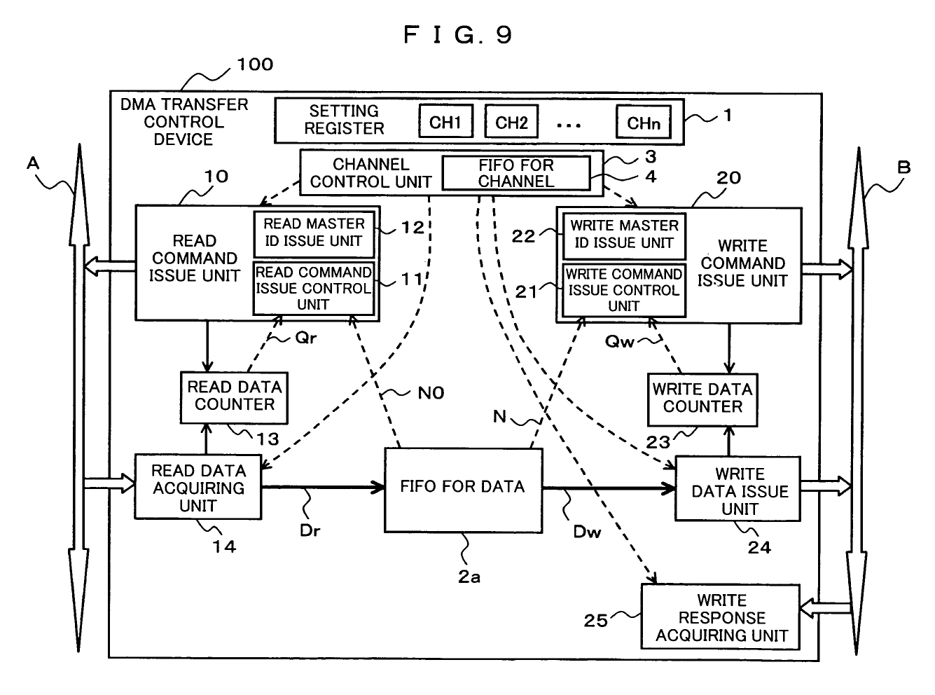

FIG. 9 is a block diagram showing a schematic configuration of a DMA transfer control device 100 according to the fifth embodiment of the present invention. In FIG. 6, the same reference numeral (s) as in FIG. 6 of the third embodiment means the same configuration element(s). In this embodiment, an FIFO 2a for data which outputs the write data Dw to the write data issue unit 24 when the read data Dr is supplied from the read data acquiring unit 14 is provided instead of the internal memory 2. Moreover, the number of pieces of free space N0 of the FIFO 2a for data is notified to the read command issue control unit 11, and the number of pieces of data amount N of the FIFO 2a for data is notified to the write command issue control unit 21. The explanation is omitted about other configurations since they are similar to those of the third embodiment.

Next, a method of the data transfer in the DMA transfer control device of this embodiment is explained. Except the part related to calculation of the data amount, the method is completely the same as that of the third Embodiment. In the FIFO 2a for data, a certain unit size is a data width of FIFO. When the read data acquired from the bus A reaches the above mentioned unit size, the read data acquiring unit 14 writes the read data Dr in the FIFO 2a for data. However, even when the above mentioned unit size is not reached, at the time of the change of channels or at the time of a jump from a continuum region of the read data to the subsequent continuum region, the read data Dr is written in the FIFO 2a for data.

The read data counter 13 counts the unread data amount number Nr corresponding to the unread data amount Qr in the above mentioned unit size. At the time of the issue of the read command, the read data counter 13 sequentially adds a number NR, or the quotient when the read data amount QR in the command divided by the unit size, to the counter value. When a fraction occurs in the read data amount number NR, the read data counter 13 rounds up the read data amount number NR and implements the above mentioned adding process. Moreover, the read data counter 13 counts down according to timing in which data is written from the read data acquiring unit 14 in the FIFO 2a for data.

Also in the write data counter 23, the counter control is performed in the similar method. The write data counter 23 counts the unwrite data amount number Nw corresponding to the unwrite data amount Qw in the above mentioned unit size. At the time of the issue of the read command, the write data counter 23 sequentially adds a number (hereafter, it is called “write data amount NW”), or the quotient when the write data amount QW in the command divided by the unit size, to the counter value. When a fraction occurs in the write data amount number NW, the write data counter 23 rounds up the write data amount number NW and adds it to the counter value. Moreover, the write data counter 23 counts down according to timing in which data is written from the FIFO 2a for data to the write data issue unit 24.

The read command issue unit 10 determines the read command to be issued on the basis of the register of the corresponding channel of the setting register 1, and calculates the read data amount number NR to be acquired on the basis of this read command. When a fraction occurs in the read data amount number NR, the read command issue unit 10 rounds up the read data amount number NR. The read command issue control unit 11 calculates the determination amount of read command reject Jr (=N0−Nr) by subtracting the unread data amount number Nr of the read data counters 13 from the number of pieces of free space N0 of the FIFO 2a for data. And then, the read command issue unit 10 determines whether or not this determination amount of read command reject Jr is equal to or more than the above-mentioned read data amount number NR (Jr>=NR).

When the result of the above-mentioned determination is affirmative, that is, when the following conditions are satisfied, the read command issue unit 10 allows the issue of the write command. The conditions are as follows:

The read data amount number NR is equal to or less than the determination amount of read command reject Jr, and

The FIFO 2a for data does not overflow even when the read data increases in the FIFO 2a for data.

The write command issue unit 20 determines the write command to be issued on the basis of the register of the corresponding channel of the setting register 1, and calculates the number of write data amount (hereafter, it is called “write data amount number NW”) issued on the basis of this write command. When the fraction occurs in the write data amount number NW when calculated, the write command issue unit 20 rounds up the value. The write command issue control unit 21 subtracts the unwrite data amount number Nw of the write data counters 23 from the number of pieces of data amount N of the FIFO 2a for data and calculates the write command acceptance/rejection determination amount Jw (=N−Nw), and then determines whether or not the calculated write command acceptance/rejection determination amount Jw is equal to or more than the above-mentioned write data amount number NW (Jw>=NW).

When the result of the above-mentioned determination is affirmative, that is, when the following conditions are satisfied, the write command issue unit 20 allows the issue of the write command. The conditions are as follows:

The write data amount number NW is equal to or less than the write command acceptance/rejection determination amount Jw, and

The write data does not underflow in the FIFO 2a for data even when the write data is issued.

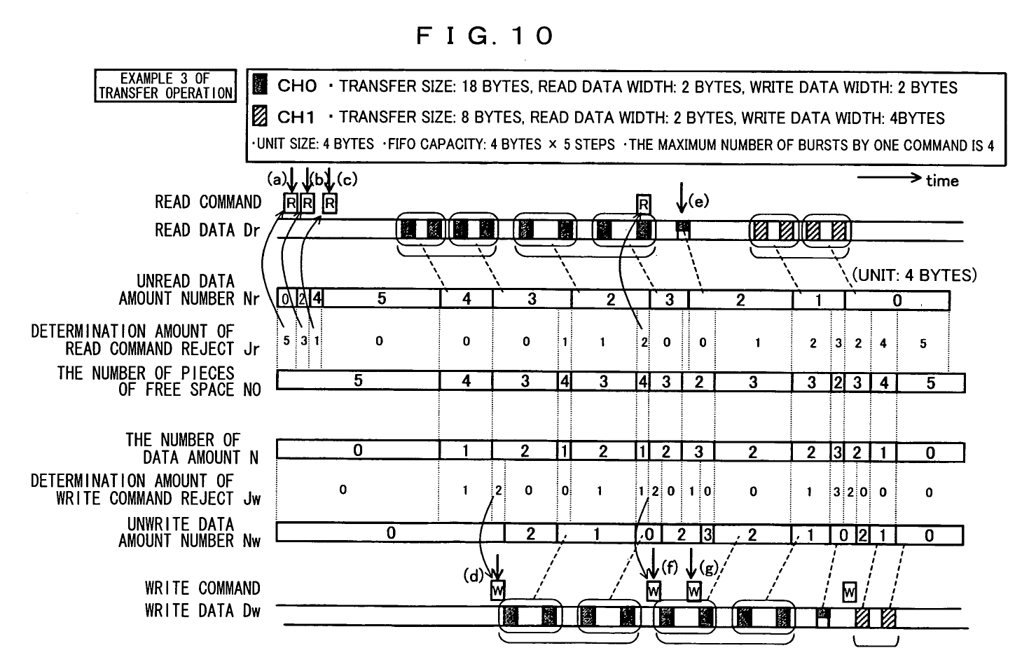

An example of transfer by this embodiment is shown in FIG. 10. In this example, the setting register 1 is set so as to satisfy the following conditions.

In channel CH0, the transfer size is 18 bytes, the read data width is 2 bytes, and the write data width is 2 bytes;

In channel CH1, the transfer size is 8 bytes, the read data width is 2 bytes, and the write data width is 4 bytes;

Any channels of all transfer a continuation field;

The unit size is 4 bytes;

The width of data is 4 bytes in the FIFO 2a for data, and the capacity is 5 pieces;

The number of bursts of the data in one command is specified as 4 times on the basis of the protocol of the connected bus A and bus B; and

The transfer is performed in the order of CH0 and CH1.

First of all, at (a) of FIG. 10, the read command issue control unit 11 calculates the read data amount number NR to acquire on the basis of the CH0 read command to be issued. The read data amount QR is determined as 8 bytes on the basis of the read data width (2 bytes) and the maximum numbers of bursts (4 times). This read data amount QR is equal to two unit sizes of data (NR=8/4=2). Moreover, the read command issue control unit 11 subtracts zero of the unread data amount number Nr from 5 of the number of pieces of free space N0 of the FIFO 2a for data, and then calculates that the determination amount of read command rejects Jr is 5 pieces (=N0−Nr=5−0). Comparing this determination amount of read command reject Jr and the above-mentioned read data amount number Nr (=2 pieces), Jr>=NR (5>2) holds. Therefore, it can be considered that the FIFO 2a for data does not overflow even when the data is read (It can be considered that the overflow can be avoided). Therefore, the read command issue control unit 11 allows the issue of the read command. Moreover, the read data counter 13 increases the unread data amount number Nr by 2 pieces on the basis of the issue of the command (Nr [symbol] Nr+NR=0+2=2).

Next, at (b) of FIG. 20, the read command issue control unit 11 determines that the read data amount QR to acquire on the basis of the read command to be issued is 8 bytes. It means that the read data amount number NR is 2 pieces in terms of unit size. Moreover, the read command issue control unit 11 calculates that the determination amount of read command reject Jr (=N0−Nr=5−2) is 3 pieces by subtracting the unread data amount numbers Nr (2 pieces) from the number of pieces of free space N0 (5 pieces) of the FIFO 2a for data. Comparing this determination amount of read command reject Jr and the above-mentioned read data amount number Nr (=2 pieces), Jr>=NR (3>2) holds. Therefore, it can be considered that the FIFO 2a for data does not overflow even when the data is read (It can be considered that the overflow can be avoided). Therefore, the read command issue control unit 11 allows the issue of the read command. Although the read command at the previous time is not completed at this timing, the required time for read data acquisition can be shortened by issuing the read command as the precedence issue.

Next, at (c) of FIG. 10, the read command issue control unit 11 determines that the read data amount number NR to acquire based on the read command to be issued is 2 bytes (18−8−8=2). The read data amount number NR determined thus does not reach 4 bytes that is the unit size. However, since it is the final read data of CH0, the read command issue control unit 11 calculates the read data amount number NR by rounding it up, and then considers the calculated read data amount number NR to be one unit size (NR=1). Moreover, the read command issue control unit 11 calculates that the determination amount of read command reject Jr (=N0−Nr=5−4) is 1 piece by subtracting the unread data amount numbers Nr (4 pieces) from the number of pieces of free space N0 (5 pieces) of the FIFO 2a for data. Comparing this determination amount of read command reject Jr and the above-mentioned read data amount number Nr (=1 pieces), Jr>=NR holds. Therefore, it can be considered that the FIFO 2a for data does not overflow even when the data is read (It can be considered that the overflow has been avoided). Therefore, the read command issue control unit 11 allows the issue of the read command, and then continues to perform the precedence issue.

The write command issue control unit 21 calculates the amount number NW of the write data issued on the basis of the write command to be issued. Write command issue control unit 21 determines that the write data amount QW is 8 bytes based on the write data width (2 bytes) and the maximum numbers of bursts (4 times). This write data amount QW is equal to 2 unit sizes of data (NW=8/4=2). When the read data Dr continues to be acquired on the basis of the issue of the read commands, the data is accumulated in the FIFO 2a for data. At (d) of FIG. 10, although the number of pieces of data amount N of the FIFO 2a for data is 2 pieces, the write command issue control unit 21 calculates that the determination amount of write command rejects Jw is 8 pieces (=N−Nw=2−0) by subtracting zero piece of the unwrite data amount number Nw from this data amount. Comparing this write command acceptance/rejection determination amount Jw and the above-mentioned write data amount number NW (=2 bytes), Jw>=NW holds. Therefore, it can be considered that data necessary for the write is secured (It can be considered that the underflow can be avoided). Therefore, the write command issue control unit 21 allows the issue of write command.

At (e) of FIG. 10, although the read data to be acquired is two bytes and does not reach 4 bytes that are the unit size, since it is the final read data of CH0, the FIFO 2a for data advances the pointer. According to this, the number of pieces of free space N0 of the FIFO 2a for data and the number of pieces of data amount N of the FIFO 2a for data are changed.

From the write command issues at (f) of FIG. 10 onward, write command issue control unit 21 calculates that the write data amount number NW based on the write command to be issued next is 2 bytes based on the write data width and the maximum number of bursts. Although this write data amount number NW does not reach 4 bytes of the unit size, since the data is the final write data of CH0, the write command issue control 21 calculates the write data amount number NW by rounding it up, and considers it to be one unit size. At (g) of FIG. 10, the FIFO number of pieces of data amount N is 3 pieces according to the read data of (e) of FIG. 10, the write command issue control unit 21 calculates that the write data amount number NW is 1 piece by subtracting 2 pieces of the unwrite data amount numbers Nw from this FIFO number of pieces of data amount N. Comparing this and the above-mentioned write data amount number NW (=1 piece), it can be considered that data necessary for the write is secured (It can be considered that the underflow can be avoided). Therefore, the write command issue control unit 21 allows the issue of write command. At this time, although 4 bytes of data are read from the FIFO 2a for data, since only 2 bytes of data are effective, these 2 bytes of data are used as the write data. Thus, even when the unit size fraction occurs, the data amount is correctly recognized and the data transfer can be executed.

In addition, these explanations are just examples, if bus protocol does not need the write response, the write response acquiring unit 25 may be omitted. Moreover, the write master ID may be ID inherent in each channel. As such, the configuration is not limited to those described above.

According to this embodiment, in each processing of read or write, since the transfer of various channels can be performed in the optimal timing according to the state of an internal memory. Moreover, the computing time and the circuit area for calculating the optimal timing can be reduced.

### Sixth Embodiment

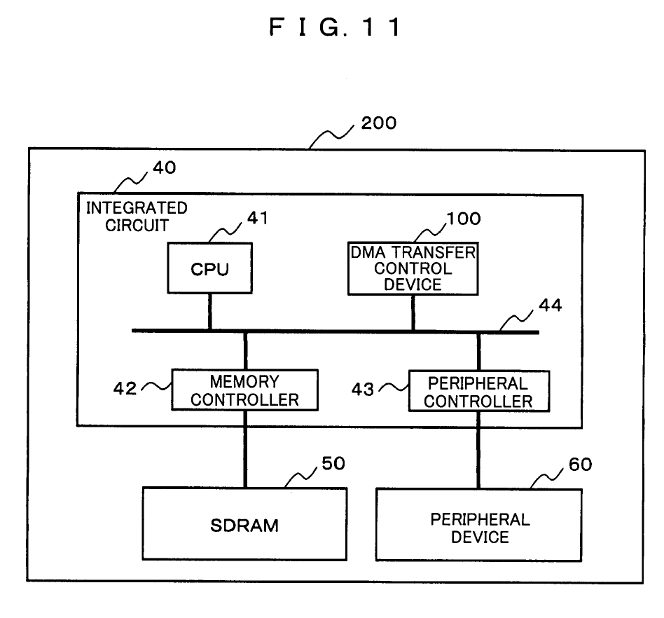

FIG. 11 is a block diagram showing a schematic configuration of a semiconductor integrated circuit device 200 in the sixth embodiment of the invention. The semiconductor integrated circuit device 200 of this embodiment includes an integrated circuit 40, an SDRAM 50, and a peripheral device 60. The integrated circuit 40 includes a CPU 41, a DMA transfer control device 100, a memory controller 42, and a peripheral controller 43, and each of them is mutually connected by a bus 44. The memory controller 42 is connected with the SDRAM 50, and the peripheral controller 43 is connected with the peripheral device 60. Moreover, the DMA transfer control device 100 includes the command precedence issue function of the present invention that was explained in one of the first to fifth embodiments.

In the semiconductor integrated circuit device 200, the case where the data transfer is performed from the SDRAM 50 to the peripheral device 60 using the DMA transfer control device 100 is considered. In the issue of command in the DMA transfer control device 100, the command is issued in precedence in the optimal timing based on the method explained in one of the first to fifth embodiments. Although the read command is sent to the SDRAM 50 via the memory controller 42, in that case, the SDRAM 50 returns the read data Dr to the DMA transfer control device 100 after waiting for a while. Therefore, the transfer rate slows. However, in this embodiment, when two or more read commands are received by the precedence issue of command, the following read command is received, and the process to the following read command is performed in parallel with the processes to a previous read command. Therefore, in the DMA transfer control device 100, the operation becomes available in which two or more read data Dr are immediately returned after the issue of two or more read commands, and then the reduction of the transfer rate is prevented.

Moreover, in the issue of the write command to the peripheral device 60, a throughput can be similarly raised by issuing commands in precedence in the optimal timing. Moreover, the same is applied to the case where the data transfer is performed to the SDRAM 50 from the peripheral device 60.

Thus, the present invention is effective in not only an external storage like the SDRAM but also in a peripheral device where the latency is large, so it is clear that the present invention is not limited to an external storage. This invention is effective also in accessing the internal functional block having a large latency, which is outside the integrated circuit 40.

Naturally, about the method of realizing the present invention, it is also possible to realize the present invention by combining two or more configurations described in the above-mentioned embodiments. Moreover, it is also possible to have a different configuration according to a protocol. For example, when a protocol is such that the write response is returned according to the write response request, an ID for each channel will be used as the write master ID, and a write response request signal will be added to the final transfer of each channel in the case of write issue. Thereby, the write response acquiring unit can recognize the completion of transfer of the channel, without using a counter. Moreover, even in the case where an integrated circuit which mounts a bus adapter thereon is used instead of the DMA transfer control device which has the function of this invention, it is similarly possible to prevent access performance from deteriorating. Thus, these indicated configurations are not restrictive.

In addition, the technique and configuration used in the embodiments of the invention mentioned above are examples, and this invention is not limited to these.

Although the most preferable concrete example about this invention was explained in detail, the combination and the array of parts of the preferred embodiment can change variously as long as they are within the spirit and the range of this invention later claimed.

What is claimed is:

1. A DMA transfer control device performing a direct memory access transfer to a transfer destination side from a transfer source side, and comprising an internal memory which stores read data temporarily, the DMA transfer control device comprising:
a read data counter configured to count an unread data amount which is a data amount not yet transferred by adding a read data amount which should be acquired by a read command one by one whenever the read command is issued, and by counting down whenever data is read; and
a read command issue control unit configured to determine whether or not a determination amount of read command reject which is obtained by subtracting the unread data amount from the free space of the internal memory is equal to or more than a read data amount of the following acquisition target, and to allow the issue of the read command when the determination result is affirmative.

2. A DMA transfer control device performing a direct memory access transfer to a transfer destination side from a transfer source side, and comprising an internal memory which stores read data temporarily, the DMA transfer control device comprising:
a write data counter configured to count an unwrite data amount which is a data amount not yet transferred by adding a write data amount which should be issued by a write command one by one whenever the write command is issued, and by counting down whenever data is written; and
a write command issue control unit configured to determine whether or not a determination amount of write command reject which is obtained by subtracting the unwrite data amount from a data amount stored in the internal memory is equal to or more than a write data amount of the following issue target, and to allow issue of the write command when the determination result is affirmative.

3. A DMA transfer control device performing a direct memory access transfer to a transfer destination side from a transfer source side, and comprising an internal memory which stores read data temporarily, the DMA transfer control device comprising:
a read data counter configured to count an unread data amount which is a data amount not yet transferred by adding a read data amount which should be acquired by a read command one by one whenever the read command is issued, and by counting down whenever data is read;
a read command issue control unit configured to determine whether or not a determination amount of read command reject which is obtained by subtracting the unread data amount by the read data counter from the free space of the internal memory is equal to or more than a read data amount of the following acquisition target, and to allow issue of the read command when the determination result is affirmative;
a write data counter configured to count an unwrite data amount which is a data amount not yet transferred by adding a write data amount which should be issued by a write command one by one whenever the write command is issued, and by counting down whenever data is written; and
a write command issue control unit configured to determine whether or not a determination amount of write command reject which is obtained by subtracting the unwrite data amount from a data amount stored in the internal memory is equal to or more than a write data amount of the following issue target, and to allow issue of the write command when the determination result is affirmative.

4. The DMA transfer control device according to claim 1, further comprising
a read master ID issue unit configured to output a read master ID which is common to each channel at the time of the issue of the read command.

5. The DMA transfer control device according to claim 2, further comprising
a read master ID issue unit configured to output a read master ID which is common to each channel at the time of the issue of the read command.

6. The DMA transfer control device according to claim 3, further comprising
a read master ID issue unit configured to output a read master ID which is common to each channel at the time of the issue of the read command.

7. The DMA transfer control device according to claim 1, further comprising:
a read command issue unit configured to issue the read command;
a write command issue unit configured to issue a write command;
a read data acquiring unit configured to acquire the read data;
a write data issue unit configured to issue write data; and
a write response acquiring unit configured to acquire a write response; wherein
the read command issue unit comprises a read command issue control unit and a read master ID issue unit, and
the write command issue unit comprises a write command issue control unit and a write master ID issue unit, and
processes of the data transfer of different channels are possible in the read command issue unit, in the write command issue unit, in the read data acquiring unit, in the write data issue unit, and in the write response acquiring unit.

8. The DMA transfer control device according to claim 2, further comprising:
a read command issue unit configured to issue the read command;
a write command issue unit configured to issue a write command;
a read data acquiring unit configured to acquire the read data;
a write data issue unit configured to issue write data; and
a write response acquiring unit configured to acquire a write response; wherein
the read command issue unit comprises a read command issue control unit and a read master ID issue unit, and
the write command issue unit comprises a write command issue control unit and a write master ID issue unit, and
processes of the data transfer of different channels are possible in the read command issue unit, in the write command issue unit, in the read data acquiring unit, in the write data issue unit, and in the write response acquiring unit.

9. The DMA transfer control device according to claim 3, further comprising:
a read command issue unit configured to issue the read command;
a write command issue unit configured to issue a write command;
a read data acquiring unit configured to acquire the read data;
a write data issue unit configured to issue write data; and
a write response acquiring unit configured to acquire a write response; wherein
the read command issue unit comprises a read command issue control unit and a read master ID issue unit, and
the write command issue unit comprises a write command issue control unit and a write master ID issue unit, and
processes of the data transfer of different channels are possible in the read command issue unit, in the write command issue unit, in the read data acquiring unit, in the write data issue unit, and in the write response acquiring unit.

10. The DMA transfer control device of claim 7, further comprising a channel control unit configured to control at least one of the following operating steps: a step in which the read data acquiring unit inherits a channel number from the read command issue unit, a step in which the write command issue unit inherits a channel number from the read data acquiring unit, a step in which the write data issue unit inherits a channel number from the write command issue unit, and a step in which the write response acquiring unit inherits a channel number from the write data issue unit.

11. The DMA transfer control device according to claim 8, further comprising
a channel control unit configured to control at least one of the following operating steps: a step in which the read data acquiring unit inherits a channel number from the read command issue unit, a step in which the write command issue unit inherits a channel number from the read data acquiring unit, a step in which the write data issue unit inherits a channel number from the write command issue unit, and a step in which the write response acquiring unit inherits a channel number from the write data issue unit.

12. The DMA transfer control device according to claim 9, further comprising
a channel control unit configured to control at least one of the following operating steps: a step in which the read data acquiring unit inherits a channel number from the read command issue unit, a step in which the write command issue unit inherits a channel number from the read data acquiring unit, a step in which the write data issue unit inherits a channel number from the write command issue unit, and a step in which the write response acquiring unit inherits a channel number from the write data issue unit.

13. The DMA transfer control device according to claim 10, wherein at least one FIFO for channel is further provided at least between the read command issue unit and the read data acquiring unit, between the read data acquiring unit and the write command issue unit, between the write command issue unit and the write data issue unit, or between the write data issue unit and the write response acquiring unit.

14. The DMA transfer control device according to claim 11, wherein
at least one FIFO for channel is further provided at least between the read command issue unit and the read data acquiring unit, between the read data acquiring unit and the write command issue unit, between the write command issue unit and the write data issue unit, or between the write data issue unit and the write response acquiring unit.

15. The DMA transfer control device according to claim 12, wherein
at least one FIFO for channel is further provided in at least one of between the read command is sue unit and the read data acquiring unit, between the read data acquiring unit and the write command issue unit, between the write command issue unit and the write data issue unit, or between the write data issue unit and the write response acquiring unit.

16. The DMA transfer control device according to claim 10, wherein:
the channel control unit comprises an FIFO for channel; and
the FIFO for channel includes at least one of a read pointer for the read command issue unit, a read pointers for said read data acquiring unit, a read pointer for the write command issue unit, a read pointer for the write data issue unit, and each read pointer for the write response acquiring unit, which operate respectively independently.

17. The DMA transfer control device according to claim 11, wherein:
the channel control unit comprises an FIFO for channel; and
the FIFO for channel includes at least one of a read pointer for the read command issue unit, a read pointers for said read data acquiring unit, a read pointer for the write command issue unit, a read pointer for the write data issue unit, and each read pointer for the write response acquiring unit, which operate respectively independently.

18. The DMA transfer control device according to claim 12, wherein:
the channel control unit comprises an FIFO for channel; and
the FIFO for channel includes at least one of a read pointer for the read command issue unit, a read pointers for said read data acquiring unit, a read pointer for the write command issue unit, a read pointer for the write data issue unit, and each read pointer for the write response acquiring unit, which operate respectively independently.

19. The DMA transfer control device according to claim 1, wherein
an unread data amount in the read data counter, and a read data amount of an acquisition target based on the read command which is due to be issued, are expressed with a unit size set up by the aforementioned DMA transfer control device.

20. The DMA transfer control device according to claim 2, wherein
an unwrite data amount in the write data counter, and a write data amount of an issue target based on the write command which is due to be issued, are expressed with a unit size set up by the aforementioned DMA transfer control device.

21. The DMA transfer control device according to claim 3, wherein
an unread data amount in the read data counter, an unwrite data amount in the write data counter, a read data amount of an acquisition target based on the read command which is due to be issued, and a write data amount of an issue target based on the write command which is due to be issued, are expressed with a unit size set up by the aforementioned DMA transfer control device.

22. The DMA transfer control device according to claim 19, wherein:
the internal memory is composed by an FIFO; and
the FIFO has a data width of the unit size, advances a write pointer even when final read data at the time of a change in the read data channel is insufficient for the unit size, and advances a read pointer even when final write data at the time of a change in the write data channel is insufficient for the unit size.

23. The DMA transfer control device according to claim 20, wherein:
the internal memory is composed by an FIFO; and
the FIFO has a data width of the unit size, advances a write pointer even when final read data at the time of a change in the read data channel is insufficient for the unit size, and advances a read pointer even when final write data at the time of a change in the write data channel is insufficient for the unit size.

24. The DMA transfer control device according to claim 21, wherein:
the internal memory is composed by an FIFO; and
the FIFO has a data width of the unit size, advances a write pointer even when final read data at the time of a change in the read data channel is insufficient for the unit size, and advances a read pointer even when final write data at the time of a change in the write data channel is insufficient for the unit size.

25. The DMA transfer control device according to claim 19, wherein:
the internal memory is composed by an FIFO; and
the FIFO has a data width of the unit size, advances a write pointer even when the final read data of a continuation field of the read data is insufficient for the unit size, and advances a read pointer even when the final write data of a continuation field of the write data is insufficient for the unit size.

26. The DMA transfer control device according to claim 20, wherein:
the internal memory is composed by an FIFO; and
the FIFO has a data width of the unit size, advances a write pointer even when the final read data of a continuation field of the read data is insufficient for the unit size, and advances a read pointer even when the final write data of a continuation field of the write data is insufficient for the unit size.

27. The DMA transfer control device according to claim 21, wherein:
the internal memory is composed by an FIFO; and
the FIFO has a data width of the unit size, advances a write pointer even when the final read data of a continuation field of the read data is insufficient for the unit size, and advances a read pointer even when the final write data of a continuation field of the write data is insufficient for the unit size.

28. A semiconductor integrated circuit device comprising:
the DMA data transfer device according to claim 1; and
an external storage as a transfer source side or a transfer destination side of the data transfer device.

29. A semiconductor integrated circuit device comprising:
the DMA data transfer device according to claim 2; and
an external storage as a transfer source side or a transfer destination side of the data transfer device.

30. A semiconductor integrated circuit device comprising:
the DMA data transfer device according to claim 3; and
an external storage as a transfer source side or a transfer destination side of the data transfer device.
